(19) United States
(12) Patent Application Publication
(10) Pub. No.: US 2024/0158083 A1
(43) Pub. Date: May 16, 2024

(54) AIRCRAFT CABIN FURNITURE INCORPORATING EQUIPMENT FOR CREW AND FOR A PASSENGER

(71) Applicant: Safran Seats, Plaisir (FR)

(72) Inventor: Julien Layet, Moissy-Cramayel (FR)

(21) Appl. No.: 18/281,548

(22) PCT Filed: Feb. 28, 2022
(86) PCT No.: PCT/EP2022/055002

§ 371 Date: Sep. 11, 2023

(30) Foreign Application Priority Data
Mar. 16, 2021 (EP) 21162976.1
Jul. 7, 2021 (FR) 2107328

(51) Int. Cl. B64D 11/04; A47B 31/00; A47B 31/02; A47B 31/06; B64D 11/00

(52) U.S. Cl. CPC B64D 11/04; A47B 31/06; A47B 2031/002; A47B 31/02; B64D 2011/0046

(57) ABSTRACT

The present invention relates to furniture for an aircraft cabin, comprising:
at least a first furniture module comprising:
a front face and a rear face,
a front part, termed “part dedicated to the crew”, containing equipment intended to be used by a member of the crew, and
a second part, termed “part dedicated to the passenger”, comprising an element specific to a passenger seat,
said part dedicated to the crew and said part dedicated to the passenger extending between the front face and the rear face of said first furniture module,
said part dedicated to the crew and said part dedicated to the passenger longitudinally overlapping one another along a longitudinal axis of said furniture.

The present invention relates to an aircraft cabin cabinet incorporating equipment for a crew member and a passenger. The invention finds a particularly advantageous, but not exclusive, application with commercial aircraft.

In a manner known per se, a kitchen module, also called a “galley”, is an aircraft interior cabinet containing in particular trolleys, storage spaces, and equipment for cooking or heating up food, such as a refrigerator, an oven, a coffee machine, a kettle, a water source or any other equipment that can be used on an aircraft to prepare a drink or a dish.

A kitchen module can contain trolleys and/or half-trolleys having a capacity less than that of a trolley. A trolley or a half-trolley is configured to store meal trays and/or drinks as well as the equipment necessary to serve them (cups, carafes, bottles, cans, or other).

On the passenger side, a seat cabinet may for example comprise a storage space having one or more elements from a literature pocket, a bottle holder, or a minibar. The choice of storage spaces is configurable according to the wishes of the airline. A cabinet can also include a housing incorporating a foot rest, also called an ottoman.

The cabinets as well as the kitchen modules are subjected to certification tests for controlling their mechanical behavior during an impact. The kitchen module and/or cabinet manufacturer must therefore justify, to the aircraft manufacturer, the compatibility between the design of the product and the certification requirements issued either by aircraft manufacturers or by civil aviation authorities.

The cabinet and the kitchen module being two distinct elements, they must be separated from each other by a space called “deflection space” in order to avoid load sharing between them during their deformation caused by an impact. This ensures that the cabins retain their structural and functional integrity in the event of an accident.

The objective of the invention is to provide a cabinet configuration allowing the elimination of deflection spaces in order to optimize the integration of passenger seats inside an aircraft cabin.

More specifically, the objective of the invention is a cabinet for an aircraft cabin comprising:
at least one first cabinet module comprising:
a front side and a back side,
a first part, called “crew member part”, containing an equipment to be used by a crew member, and
a second part, called “passenger part”, comprising an element specific to a passenger seat,
said crew member part and passenger part extending between the front side and the rear side of said first cabinet module,
said crew member and passenger parts longitudinally overlapping each other along a longitudinal axis of said cabinet.

The invention thus makes it possible, by integrating the crew member part and passenger part in the same cabinet in order to eliminate the deflection space between two separate conventional cabinets. The invention thus reduces the space between the front side and the rear side of an aircraft seat cabinet while retaining the same storage volume and without compromising comfort for the passenger. The invention also makes it possible to make the layout of seats denser by authorizing in certain cases the installation of an additional row of seats inside the aircraft cabin.

According to one embodiment of the invention, the crew part comprises a kitchen module containing at least one element chosen from: a trolley, a half-trolley, a refrigerator, or an oven.

According to one embodiment of the invention, the crew member part comprises a storage space containing an equipment to be used by a crew member.

According to one embodiment of the invention, the crew member part includes a multimedia systems control center.

According to one embodiment of the invention, the crew member part comprises a housing in which is arranged a foot rest.

According to one embodiment of the invention, the passenger part comprises a space for receiving a meal flap in the stored state.

According to one embodiment of the invention, the passenger part comprises a passenger seat certified or not in the landing and take-off phase.

According to one embodiment of the invention, the passenger part includes a storage space for a Moses basket.

According to one embodiment of the invention, the passenger part carries a multimedia system video screen.

According to one embodiment of the invention, the crew member part has a height greater than a height of the passenger part.

According to one embodiment of the invention, the crew member part and the passenger part have a common partition wall.

According to one embodiment of the invention, the common partition wall forms a non-zero angle with respect to the longitudinal axis of the cabinet.

According to one embodiment of the invention, said cabinet further comprises a second cabinet module having a front side and a rear side, said rear side of the second cabinet module being attached to the front side of the first cabinet module without deflection space between the rear side of the second cabinet module and the front side of the first cabinet module.

According to one embodiment of the invention, said cabinet further comprises a third cabinet module having a front side and a rear side, said rear side of the third cabinet module being attached to the front side of the second cabinet module without deflection space between the front side of the second cabinet module and the rear side of the third cabinet module.

The invention also relates to an aircraft cabin comprising at least one seat unit and at least one cabinet as previously defined.

The present invention will be better understood and other characteristics and advantages will become apparent on reading the following detailed description comprising embodiments given by way of illustration with reference to the appended figures, presented by way of non-limiting examples, which may be used to complete the understanding of the present invention and the presentation of the realization thereof and, if necessary, contribute to the definition thereof, in which:

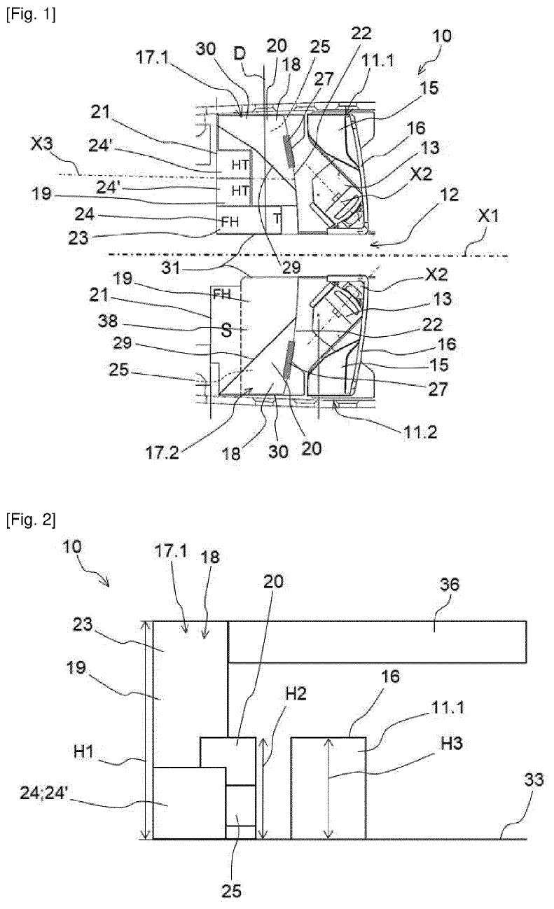

FIG. 1 is a partial top view of a single-aisle aircraft cabin comprising two seat units and two cabinets each comprising a crew member part and a passenger part;

FIG. 2 is a schematic side representation of an assembly formed by an aircraft cabin cabinet according to the invention and an associated seat unit;

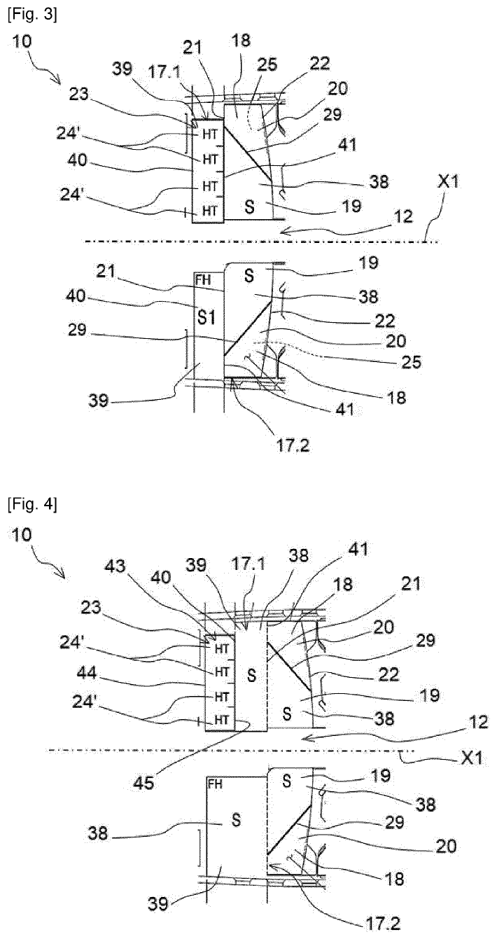

FIG. 3 is a top view of a first alternative embodiment of aircraft cabin cabinets according to the present invention;

FIG. 4 is a top view of a second alternative embodiment of aircraft cabin cabinets according to the present invention;

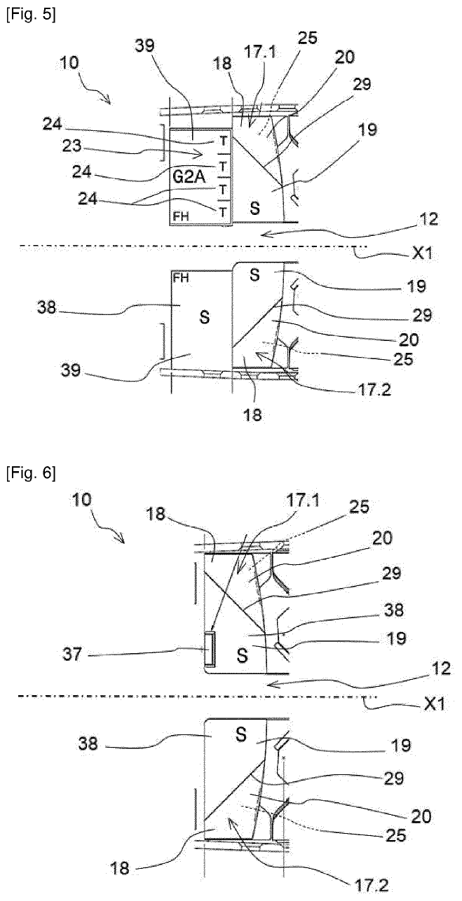

FIG. 5 is a top view of a third embodiment of aircraft cabin cabinets according to the present invention;

FIG. 6 is a top view of a fourth embodiment of aircraft cabin cabinets according to the present invention;

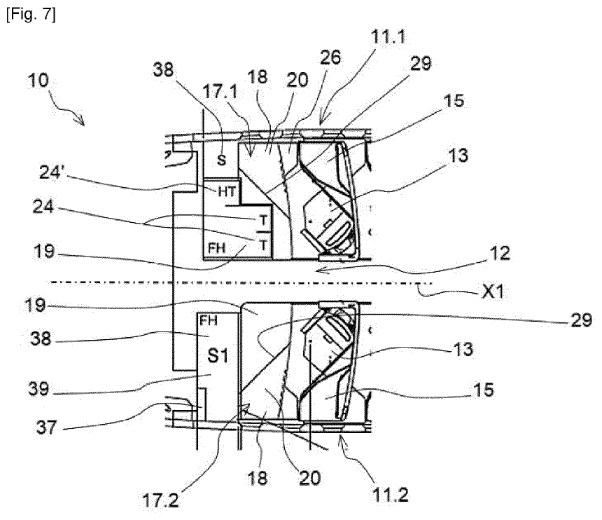

FIG. 7 is a top view of a fifth embodiment of aircraft cabin cabinets according to the present invention.

It should be noted that the structural and/or functional elements common to the different embodiments have the same references. Thus, unless otherwise stated, such elements have identical structural, dimensional and material properties.

Furthermore, the relative terms as “horizontal” or “vertical” are understood by reference to the common meaning given to them by a passenger seated in an aircraft seat.

FIG. 1 is a partial view of a single-aisle aircraft cabin 10 with longitudinal axis X1 comprising two seat units 11.1, 11.2 separated from each other by an aisle 12. Each seat unit 11.1, 11.2 conventionally comprises a seat 13 associated with a side console 15 provided in particular with storage spaces. These storage spaces, such as a literature pocket, a bottle holder, or a minibar can be configured according to the wishes of the airline. A privacy shell 16 at least partly surrounds a corresponding seat 13 so as to delimit a semi-enclosed space around the passenger. Such a configuration makes it possible to guarantee the privacy of the passenger seated in the seat 13.

The seat 13 is advantageously provided with a kinematics allowing it to be movable between a “seated” position and a “lying” position. In the seated position used in particular during the stopping, take-off and landing phases of the aircraft, the seat 13 is configured to define a seated position for a passenger. In the “lying” position, the seat 13 is configured to define a flat surface, advantageously substantially horizontal. Intermediate comfort positions can also be proposed, such as the “relax” position in which the seat back 13 is strongly inclined.

A seat 13 has an axis X2 defined by an intersection between a horizontal plane and a vertical median plane of the seat 13. This median plane can correspond globally to a plane of symmetry of the seat 13. The axis X2 of a seat 13 forms a non-zero angle with respect to the longitudinal axis X1 of the aircraft cabin 10, for example of the order of 45 degrees. In this case, the two seats 13 shown are turned in a direction opposite the longitudinal axis X1 of the aircraft cabin 10. This corresponds to a reverse herringbone configuration. As a variant, in a classic herringbone configuration, the seats 13 are turned in the direction of the longitudinal axis X1. Alternatively, the axes X2 of the seats 13 may extend parallel to the longitudinal axis X1 of the aircraft cabin 10.

Each seat unit 11.1, 11.2 is arranged opposite a corresponding cabinet 17.1, 17.2. A cabinet 17.1, 17.2 comprises at least a first cabinet module 18 comprising a first part 19, called “crew member part”, containing an equipment to be used by a crew member and a second part 20, called “passenger part”, comprising an element specific to a passenger seat 13.

The crew member part 19 and the passenger part 20 extend between a front side 21 and a rear side 22 of the first cabinet module 18. The front side 21 faces a space dedicated to the crew member. The rear side 22 faces the opposite side towards a seat unit 11.1, 11.2. The cabinet module 18 also comprises two lateral sides 30, 31 arranged respectively on the side of a wall of the aircraft cabin and on the side of the aisle.

The crew member part 19 and the passenger part 20 longitudinally overlap each other along a longitudinal axis X3 of said cabinet 17.1. The longitudinal axis X3 of a cabinet 17.1, 17.2 is parallel to the longitudinal axis X1 of the aircraft cabin 10. Due to the longitudinal overlap of the two parts 19 and 20 of a cabinet 17.1, 17.2, there is at least one straight line D perpendicular to the longitudinal axis X3 of the cabinet 17.1, 17.2 which intersects the first part 19 and the second part 20 of a cabinet 17.1, 17.2.

In the embodiment in FIG. 1, the crew member part 19 of the cabinet 17.1 comprises a kitchen module 23 containing at least one element chosen from: a trolley, a half-trolley, a refrigerator, or an oven. In the example shown, the crew member part 19 contains one trolley 24 and two half-trolleys 24′. Of course, the number and capacity of the trolleys 24 integrated in a kitchen module 23 may vary depending on the configuration of the cabinet 17.1 and the aircraft capacity.

Furthermore, the passenger part 20 comprises a housing in which is arranged a foot rest 25 (also called an ottoman). The housing is open towards the corresponding seat unit 11.1, 11.2. When the seat 13 is in the lying position, the flat surface defined by the seat 13 is located at the same level and preferably in the extension of the corresponding foot rest 25. The flat surface of the seat 13 in the lying position and the inner surface of the foot rest 25 thus define a bed surface for the passenger. The foot rest 25 has an axis parallel or coincident with the axis of the corresponding seat 13.

A video screen 27 of a multimedia system called IFE system (for “Inflight Entertainment System”) can be placed on the rear side of the passenger part.

The crew member part 19 and the passenger part of the first cabinet module 18 advantageously have a common partition wall 29. The common partition wall 29 forms a non-zero angle with respect to the longitudinal axis X3 of the cabinet 17.1. Thus, the crew member part 19 and the passenger part 20 each have a trapezoidal shape.

The crew member part 19 and the passenger part 20 of the first cabinet module 18 have openings in two different directions so as to respectively allow access to an element of the kitchen module (trolley or other) by a crew member and access to the footrest 25 by the passenger.

As can be seen in FIG. 2, the crew member part 19 of the cabinet 17.1 has a height H1 greater than a height H2 of the passenger part 20. The heights H1, H2 are measured with respect to a floor 33 of the aircraft cabin. Indeed, the kitchen module 23 may extend along an entire height H1 of the aircraft cabin 10 in a so-called “full height” configuration. The kitchen module 23 may then comprise one or more trolleys 24 or half-trolleys 24′ in the lower part as well as equipment such as an oven, a refrigerator, a coffee machine or other in the upper part.

The passenger part 20 comprising the foot rest 25 has a height H2 lower than that of a luggage rack 36 in the upper part of the aircraft cabin 10. According to such a configuration, called “half eight” or “underbin” configuration. This height H2 may correspond to a height H3 of a shell 16 of a seat unit 11.1, 11.2.

In the lower part, the cabinet 17.1 can be fixed on fixing rails for the floor 33 of the aircraft cabin 10. The part 19 forming the kitchen module 23 can be fixed to a wall of the aircraft cabin in the upper portion thereof by means of fasteners provided for this purpose.

The crew member part 19 of the cabinet 17.2 includes a storage space 38 which can contain equipment to be used by a crew member, such as a wheelchair or curtains for a rest area.

As a variant, the crew member part 19 comprises a multimedia systems control center called VCE for “Video Crew Center”, which makes it possible to manage the operation of the multimedia systems associated with the passenger seats 13 of the aircraft cabin 10. The control center may include for example a computer on a desk associated with a seat.

In the embodiment in FIG. 3, the cabinet 17.1 comprises a first cabinet module 18 provided with a passenger part 20 comprising a foot rest 25 and a crew member part 19 comprising a storage space 38.

The cabinet 17.1 further comprises a second cabinet module 39 comprising a kitchen module 23. The second cabinet module 39 is attached to the first cabinet module 18. The kitchen module 23 has four half-trolleys 24′ arranged next to each other. The number of half-trolleys 24′ may of course vary according to the configuration of the aircraft cabin 10 and the aircraft capacity.

The second cabinet module 39 has a front side 40 and a rear side 41. The rear side 41 of the second cabinet module 39 is joined to the front side 21 of the first cabinet module 18 with no deflection space between the rear side 41 of the second cabinet module 39 and the front side 21 of the first cabinet module 18.

The cabinet 17.2 comprises a first cabinet module 18 provided with a passenger part 20 comprising a foot rest 25 and a crew member part 19 comprising a storage space 38. The cabinet 17.2 further comprises a second cabinet module 39 comprising a storage space 38.

The assembly between a first cabinet module 18 and a second cabinet module 39 of a corresponding cabinet 17.1, 17.2 can be carried out via fixing means, such as screws, rivets, studs, or any other fixing means suitable for the application. A cabinet 17.1, 17.2 is made in several modules, in particular two or more cabinet modules, to allow the passage thereof through the door of the aircraft cabin 10.

In the embodiment in FIG. 4, the cabinet 17.1 comprises a first cabinet module 18 provided with a passenger part 20 comprising a foot rest 25 and a crew member part 19 comprising a storage space 38.

The cabinet 17.1 further comprises a second cabinet module 39 comprising a storage space 38 and a third cabinet module 43 forming a kitchen module 23. The third cabinet module 43 includes four trolleys 24 arranged next to one another. Of course, the number of trolleys 24 may vary according to the configuration of the aircraft cabin 10 and the aircraft capacity.

The first cabinet module 18, the second cabinet module 39, and the third cabinet module 43 are distinct modules with respect to each other. The cabinet modules are assembled in pairs by fixing means such as screws, rivets, studs, or any other fixing means suitable for the application.

A front side 21 of the first cabinet module 18 is joined to a rear side 41 of the second cabinet module 39 with no deflection space between the rear side 41 of the second cabinet module 39 and the front side 21 of the first cabinet module 18.

Furthermore, the third cabinet module 43 having a front side 44 and a rear side 45, the front side 40 of the second cabinet module 39 is joined to the rear side 45 of the third cabinet module 43 without deflection space between the rear side 45 of the third cabinet module 43 and the front side 40 of the second cabinet module 39.

The cabinet 17.2 comprises a first cabinet module 18 provided with a passenger part 20 comprising a foot rest 25 and a crew member part 19 comprising a storage space 38. The cabinet 17.2 further comprises a second cabinet module 39 comprising a storage space 38.

In the embodiment in FIG. 5, the cabinet 17.1 comprises a first cabinet module 18 provided with a passenger part 20 comprising a foot rest 25 and a crew member part 19 comprising a storage space 38.

The cabinet 17.1 further comprises a second cabinet module 39 formed by a kitchen module 23. The kitchen module 23 comprises four trolleys 24 arranged next to one another. In other words, the configuration of the cabinet 17.1 is similar to that of the cabinet 17.1 in FIG. 3, except that the half-trolleys 24′ have been replaced with trolleys 24.

The cabinet 17.2 comprises a first cabinet module 18 provided with a passenger part 20 comprising a foot rest 25 and a crew member part 19 comprising a storage space 38. The cabinet 17.2 further comprises a second cabinet module 39 comprising a storage space 38.

As before, the various modules of each cabinet 17.1, 17.2 are attached to each other with no deflection space between them.

In the embodiment in FIG. 6, the cabinet 17.1 comprises a first cabinet module 18 provided with a passenger part 20 comprising a foot rest 25 as well as a passenger seat 26, certified or not in the landing and takeoff phase.

The first cabinet module 18 further comprises a crew member part 19 comprising a storage space 38 as well as a crew member seat 37 called CAS seat for “Cabin Attendant Seat”.

The cabinet 17.2 comprises a first cabinet module 18 provided with a passenger part 20 comprising a foot rest 25 and a crew member part 19 comprising a storage space 38.

In the embodiment in FIG. 7, the cabinet 17.1 comprises a first cabinet module 18 provided with a passenger part 20 comprising a foot rest 25 as well as a passenger seat 26 certified or not in the landing and take-off phase.

The first cabinet module 18 further comprises a crew member part 19 comprising a kitchen module 23 comprising two trolleys 24 and a half-trolley 24′ as well as a lateral storage space 38.

The cabinet 17.2 comprises a first cabinet module 18 provided with a passenger part 20 comprising a foot rest 25 and a crew member part 19 comprising a storage space 38. A second cabinet module 39 comprises a space storage 38 and a crew member seat 37.

Alternatively, the passenger part 20 may comprise a space for receiving a meal flap in the stored state and/or a storage space 38 for a Moses basket, or a minibar.

The invention may be implemented with aircraft cabins other than single-aisle cabins, in particular aircraft cabins with two aisles 12 or more. In addition, the number of cabinets 17.1, 17.2 inside the aircraft cabin 10 can be adapted according to the space available and the need. It is therefore not essential to systematically provide two cabinets 17.1, 17.2 as in the examples shown in the figures for a particular type of cabin. It will thus be possible to produce aircraft cabins comprising a single cabinet or more than two cabinets 17.1, 17.2.

Of course, the different features, variants and/or embodiments of the present invention can be associated with each other in various combinations insofar as they are not incompatible with or exclusive of each other.

Furthermore, the invention is not limited to the embodiments described above and provided solely by way of example. It encompasses various modifications, alternative forms and other variants that a person skilled in the art may consider in the context of the present invention and in particular all combinations of the various modes of operation described previously, which may be taken separately or in combination.

1. Cabinet for an aircraft cabin characterized in that it comprises:
at least one first cabinet module comprising:
a front side and a rear side,
a first part, called “crew member part”, containing an equipment to be used by a crew member, and
a second part, called “personnel part”, comprising an element specific to a passenger seat,
said crew member part and said passenger part extending between the front side and the rear side of said first cabinet module,
said crew member part and said personnel part longitudinally overlapping each other along a longitudinal axis of said cabinet.

2. Cabinet according to claim 1, characterized in that the crew member part comprises a kitchen module containing at least one element chosen from: a trolley, a half-trolley, a refrigerator, or an oven.

3. Cabinet according to claim 1, characterized in that the crew member part comprises a storage space containing an equipment to be used by a crew member.

4. Cabinet according to claim 1, characterized in that the passenger part comprises a passenger seat certified or not in the landing and take-off phase.

5. Cabinet according to claim 1, characterized in that the crew member part has a height greater than a height of the passenger part.

6. Cabinet according to claim 1, characterized in that the crew member part and the part for the passenger have a common partition.

7. Cabinet according to claim 6, characterized in that the common partition wall forms a non-zero angle with respect to the longitudinal axis of the cabinet.

8. Cabinet according to claim 1, characterized in that it further comprises a second cabinet module having a front side and a rear side, said rear side of the second cabinet module being attached to the front side of the first cabinet module with no deflection space between the rear side of the second cabinet module and the front side of the first cabinet module.

9. Cabinet according to claim 8, characterized in that it further comprises a third cabinet module having a front side and a rear side, said rear side of the third cabinet module being attached to the front side of the second cabinet module with no deflection space between the front side of the second cabinet module and the rear side of the third cabinet module.

10. Aircraft cabin comprising at least one seat unit and at least one cabinet as defined according to any one of the preceding claims.
